(19) United States
(12) Patent Application Publication
(10) Pub. No.: US 2015/0066806 A1
(43) Pub. Date: Mar. 5, 2015

(54) QUANTITATIVE PRODUCT FEATURE ANALYSIS

(71) Applicant: International Business Machines Corporation, Armonk, NY (US)

(72) Inventors: Priyam Aneja, New Delhi (IN); Vijay Bharti, Jamshedpur (IN); Rohit Jain, Pune (IN); Jeremiah Joseph, Pune (IN); Hemant K. Sivaswamy, Pune (IN)

(21) Appl. No.: 14/312,834

(22) Filed: Jun. 24, 2014

Related U.S. Application Data
(63) Continuation of application No. 14/011,001, filed on Aug. 27, 2013.

(51) Int. Cl. G06Q 30/02

(52) U.S. Cl. CPC G06Q 30/0282
USPC 705/347

(57) ABSTRACT

Providing product review related information to a product review user by: (i) determining a plurality of products having a common product type; (ii) determining a plurality of product features of the plurality of products of the common product type; and (iii) determining, independently of any input from the product review user, a plurality of feature clusters, with each feature cluster including at least two features of the plurality of product features. This software-defined clustering of product features can help review users find the most suitable products and/or services.

### FIELD OF THE INVENTION

The present invention relates generally to the field of product and service reviews (for example, customer reviews) communicated over computer networks, and more particularly to such reviews where product features of a single product or service are rated separately (“feature-wise reviews”).

### BACKGROUND OF THE INVENTION

Typically, a customer, while shopping through e-commerce sites, heavily relies on customer feedback and reviews. These reviews are typically written by: (i) a product customer who owns and/or uses the product or service; (ii) the product manufacturer; (iii) the product re-seller; and/or (iv) other third parties (for example, review prepared for a mass media periodical). Often the customer reviews are considered to be more valued for being: (i) based on experience; and/or (ii) comparatively less biased. However, reading through thousands of customer reviews about any specific product can be tedious and/or inconclusive. This can be especially true when customer reviews are written and/or aggregated on the internet because: (i) it becomes efficient to collect a great many reviews in one “place” (for example, one e-commerce website); and (ii) customers are relatively numerous (when compared to other possible sources of product reviews, such as experts or manufacturers).

Currently, the method which has been adopted by most of the e-commerce sites is the star pattern method of rating products. In this form of rating, a product which has the highest positive customer feedback gets the maximum number of stars. Some of them segregate the feedback into positive and negative sentiments. Typically, star ratings are at the product level and not at the feature level. The current star rating pattern of customer reviews often does not provide insight into the details of the individual features in a product the user is looking for. In this example, the user is a potential customer for a product or service, although some users of customer reviews may use the reviews for other reasons. Suppose a user wants to have the breakdown of how good, or bad, the features are in a product. That user still needs to go and read through all the reviewers' feedback, and this process of reading voluminous feedback will often be inadequate and/or time consuming.

### SUMMARY

According to an aspect of the present invention, there is a method of providing product review related information to a product review user. The method includes the following steps (not necessarily in the following order): (i) determining a plurality of products having a common product type; (ii) determining a plurality of product features of the plurality of products of the common product type; and (iii) determining, independently of any input from the product review user, a plurality of feature clusters, with each feature cluster including at least two features of the plurality of product features.

### BRIEF DESCRIPTION OF THE SEVERAL VIEWS OF THE DRAWINGS

FIG. 1A is a schematic view of a first embodiment of a computer system (that is, a system including one or more processing devices) according to the present disclosure;

FIG. 1B is a schematic view of a computer sub-system (that is, a part of the computer system that itself includes a processing device) portion of the first embodiment computer system;

FIG. 2 is a first flowchart showing a process performed, at least in part, by the first embodiment computer system;

FIG. 3 is a schematic view of a portion of the first embodiment computer system;

FIG. 4 is a first screenshot generated by the first embodiment computer system;

FIG. 5 is a schematic view of a portion of a second embodiment of a computer system according to the present disclosure;

FIG. 6 is a second flowchart showing a process performed according to an embodiment of the present invention;

FIG. 7 is a third flowchart showing a process performed according to an embodiment of the present invention; and

FIG. 8 is a fourth flowchart showing a process performed according to an embodiment of the present invention.

### DETAILED DESCRIPTION

This Detailed Description section is divided into the following sub-sections: (i) The Hardware and Software Environment; (ii) Operation of a First Embodiment; (iii) Further Comments and/or Embodiments; and (iv) Definitions.

### I. THE HARDWARE AND SOFTWARE ENVIRONMENT

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer readable program code/instructions embodied thereon.

Any combination of computer-readable media may be utilized. Computer-readable media may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of a computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java (note: the term(s) “Java” may be subject to trademark rights in various jurisdictions throughout the world and are used here only in reference to the products or services properly denominated by the marks to the extent that such trademark rights may exist), Smalltalk, C++ or the like and conventional procedural programming languages, such as the “C” programming language or similar programming languages. The program code may execute entirely on a user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer-implemented process such that the instructions which execute on the computer or other programmable apparatus provide processes for implementing the functions/acts specified in the flowchart and/or block diagram block or blocks.

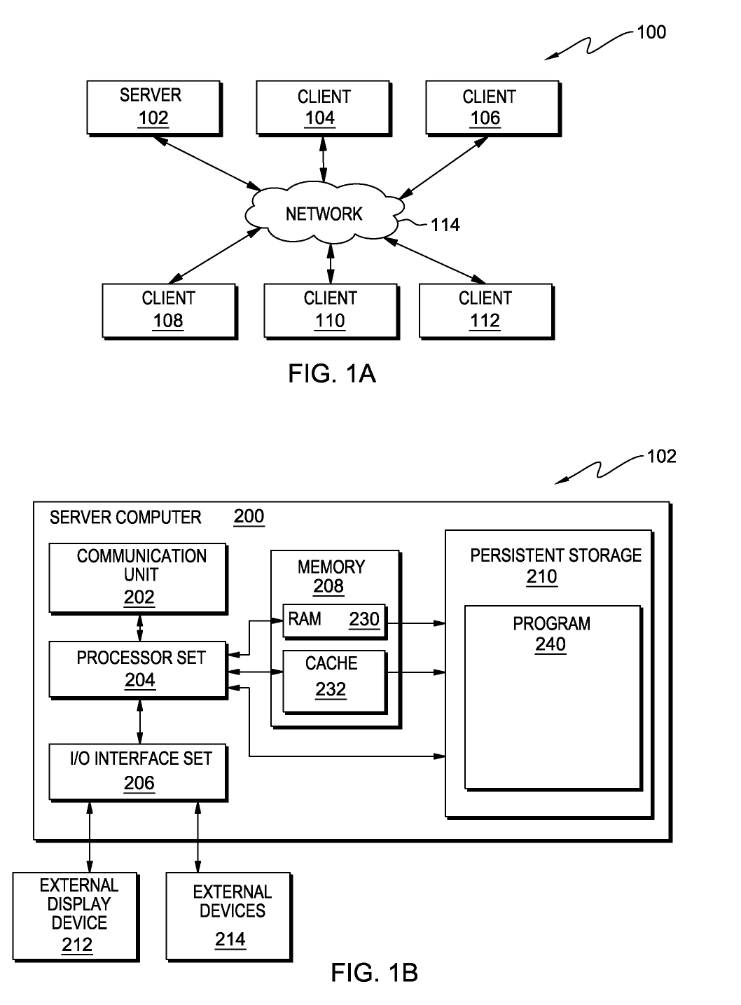

An embodiment of a possible hardware and software environment for software and/or methods according to the present invention will now be described in detail with reference to the FIGS. 1A and 1B which collectively make up a functional block diagram illustrating various portions of distributed data processing system 100, including: server computer sub-system (that is, a portion of the larger computer system that itself includes a computer) 102; client computer sub-systems 104, 106, 108, 110, 112; communication network 114; server computer 200; communication unit 202; processor set 204; input/output (i/o) interface set 206; memory device 208; persistent storage device 210; external display device 212; external device set 214; random access memory (RAM) devices 230; cache memory device 232; and program 240.

As shown in FIG. 1A, server computer sub-system 102 is, in many respects, representative of the various computer sub-system(s) in the present invention. Accordingly, several portions of computer sub-system 102 will now be discussed in the following paragraphs.

Server computer sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 240 is a collection of machine readable instructions and/or data that is used to create, manage and control certain software functions that will be discussed in detail, below, in the Operation of the Embodiment(s) sub-section of this Detailed Description section.

Server computer sub-system 102 is capable of communicating with other computer sub-systems via network 114 (see FIG. 1A). Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

It should be appreciated that FIGS. 1A and 1B, taken together, provide only an illustration of one implementation (that is, system 100) and does not imply any limitations with regard to the environments in which different embodiments may be implemented. Many modifications to the depicted environment may be made, especially with respect to current and anticipated future advances in cloud computing, distributed computing, smaller computing devices, network communications and the like.

As shown in FIG. 1B, server computer sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 240 is stored in persistent storage 210 for access and/or execution by one or more of the respective computer processors 204, usually through one or more memories of memory 208. Persistent storage 210: (i) is at least more persistent than a signal in transit; (ii) stores the device on a tangible medium (such as magnetic or optical domains); and (iii) is substantially less persistent than permanent storage. Alternatively, data storage may be more persistent and/or permanent than the type of storage provided by persistent storage 210.

Program 240 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102, such as client sub-systems 104, 106, 108, 110, 112. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface(s) 206 allows for input and output of data with other devices that may be connected locally in data communication with server computer 200. For example, I/O interface 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 240, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. OPERATION OF A FIRST EMBODIMENT

Preliminary note: The flowchart and block diagrams in the following Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

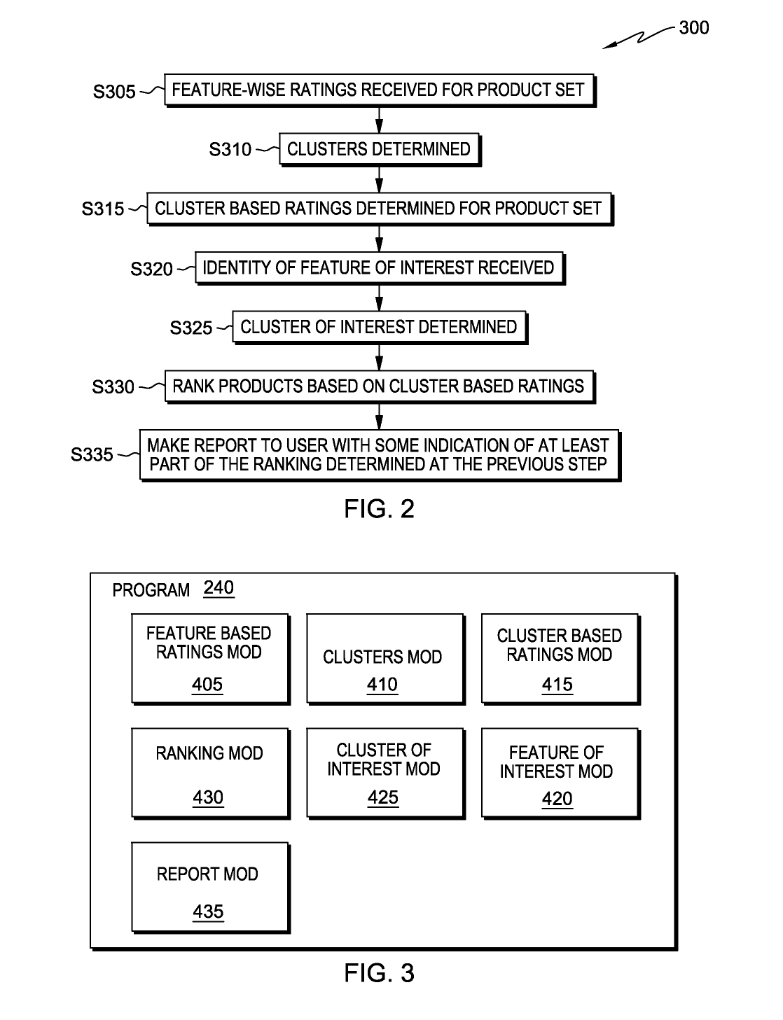

FIG. 2 shows a flow chart 300 depicting a method according to the present invention. FIG. 3 shows program 240 for performing at least some of the method steps of flow chart 300. This method and associated software will now be discussed, over the course of the following paragraphs, with extensive reference to FIG. 2 (for the method step blocks) and FIG. 3 (for the software blocks).

Processing begins at step S305, where feature based ratings module (or “mod”) 405 receives feature-wise ratings for a set of products (see definition of “product,” below, in definitions sub-section). In this embodiment, these reviews and their associated ratings of individual product feature come from reviews written on an e-commerce website by people who have used the product, where these reviews include all of the following: (i) a narrative portion; (ii) an explicit rating of the product; and (iii) the explicit ratings of product's individual features. Alternatively or additionally, the feature-wise product ratings may come from other sources, such as the following: (i) reviews written on an e-commerce website by people who have used the product, where ratings of the product and the ratings of product's individual features are inferred from the review (this possibility is further discussed below); (ii) expert reviews (with explicit or implicit product feature ratings); (iii) customer comment cards that customers have filled out by hand as part of a mailed survey; and/or (iv) customer comments made during a telephone survey.

Processing proceeds to step S310 where clusters mod 410 determines a set of clusters of features. The clustering is the determination that certain sub-sets of the product features are mutually related in some way.

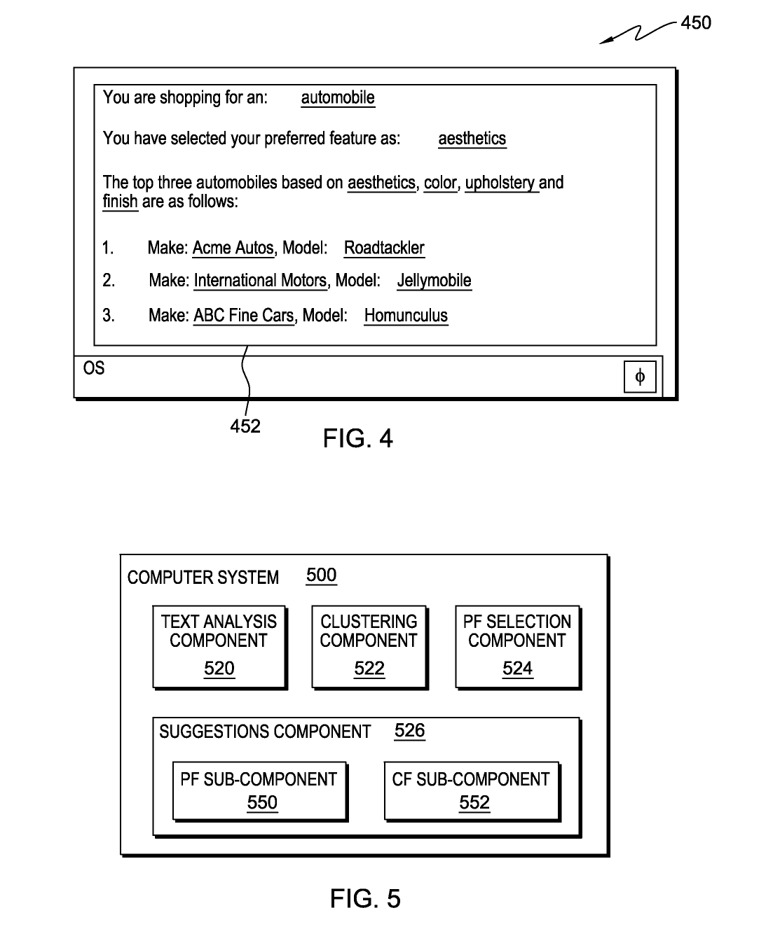

This relationship that causes a cluster to be properly determined may be a functional or operative relationship. For example, in window 452 of screenshot 450 of FIG. 4, four clustered features of an automobile are as follows: (i) aesthetics; (ii) finish; (iii) upholstery; and (iv) color. These features are functionally or operatively related because they all closely relate to the visual impact that an automobile makes on those who see it. Another possible feature cluster for an automobile might be: (i) power; and (ii) fuel economy. These are functionally and/or operationally related because more power usually means less favorable fuel economy and vice versa. Some features may be clustered for economic reasons. For example, people who prefer one “luxury” feature of an automobile may have heighted care and/or concern for other “luxury” features, even though the various “luxury” features bear no operative or functional relationship to each other, Other product features may be clustered only because there is a tendency amongst people who care about one feature in the cluster to also have heightened concern and/or attention to other features in the cluster. For example, even though there is no immediately apparent reason why, assume that people who like hatchback style automobiles also tend to strongly prefer automatic transmission and that people who like sedan style automobiles tend to strongly prefer manual transmission. If this assumption were true then it would make sense to put transmission and body style into a cluster, even though there is no easily discernable reason for the association of respective automobile features in the minds of prospective automobile customers.

In this embodiment, mod 410 will cluster features if there is any basis for believing that if a potential customer has a heightened interest in one of the features in the cluster is likely to have (or likely to come to have) an interest in the other clustered features. Alternatively, other embodiments may be more limited with respect to the underlying reason(s) for making its clusters. For example, one alternative embodiment will only cluster features if they bear some functional and/or operative relationship to each other.

In this embodiment, clusters mod 410 bases it's clustering on the narrative portions of the product reviews received at step S305. In this embodiment, the algorithm used by clusters mod 410 is relatively simple. Specifically, this algorithm looks for mention of multiple product features (or their known synonyms) within the “four corners” of the narrative portion of a single product review. Features that are most often mentioned together across the entire pool of received reviews will be designated as clusters. In this embodiment, there is no attempt to figure out whether the clustered features are operationally related, or to understand why product reviewers tend to mention the clustered features within a single product review. This is somewhat different than the approach taken in the embodiment explained in detail in the next sub-section of this detailed description section, where text analytics, which is a more sophisticated approach, is used on the narrative portions of a pool of pre-existing product reviews to help make the clusters.

As a further alternative, product reviews may be used in other (or additional) ways to determine the identities of constituent features that make up each feature cluster. As a very simple example, the product reviews might explicitly indicate which features that the product reviewers believed to be related. As a slightly more complicated example, it may be possible to infer (or at least help infer) clusters from quantitative ratings of feature ratings in the product reviews. However, even in embodiments where a reviewer helps identify the clusters, this should not be confused with the separate idea of a user of product reviews defining a cluster. As will be seen in discussion of subsequent steps of process 300, in some embodiments of the present disclosure product review users do not define clusters (even if product reviewers do help define the clusters).

As a further alternative basis for performing step S310, the clusters may not come from product reviews at all. In some embodiments of the present invention, clusters may be defined, in whole or in part, by one, or more, items on the following non-exhaustive list of cluster definition source information: (i) human experts; (ii) software that looks beyond pre-existing product reviews to the totality of knowledge about the products and/or product features involved; and/or (iii) a review of warranty claim databases. It is noted that none of the foregoing ways involves cluster definition by the review user. In process 300, and at least some other embodiments of the present disclosure, the clusters are defined before a given review user enters the picture.

Processing proceeds to step S315 where cluster based ratings mod 415 determines cluster-by-cluster ratings for each cluster of features. In this embodiment, the rating of a cluster feature is simply the arithmetic mean of the average ratings of the features (received at step S305) that make up the cluster. Alternatively, there may be other ways to determine the cluster ratings, such as by weighted averages, use of median ratings and so on. The cluster ratings may help capture useful information that the individual product ratings do not capture, or communicate, as well. For example, imagine a two-feature cluster of: (i) fuel economy; and (ii) acceleration. The cluster rating will tend to normalize the fuel economy against how much power the automobile has. In other words, if two models of automobile score the same on fuel economy, but one of the models has better acceleration, then potential customers who want good fuel economy would be expected to prefer the model with better acceleration. In this case, it is the clustering of these features, and their associated cluster ratings, that can help the potential customers fully appreciate this potentially important consumer subtlety.

Processing proceeds to step S320 where feature of interest mod 420 receives a feature of interest. This is the product review user's PF (Preferred Feature). At step S320, the product review user has now entered the picture and has communicated what kind of product, and what specific feature of that product, are of interest. In many cases, the product review user will be a potential customer and the PF will be the product feature that the potential customer is the most concerned about. In some embodiments, the review user may enter more than one PF, but this should not be confused with a cluster. At least some embodiments of the present invention do not use multiple PFs as a cluster and do not provide a collective rating, or ranking, based on the multiple PFs. As will be seen below, the entered PF, or multiple PFs, are used to determine clusters, but these clusters are not defined by the same party that enters the PF(s). As shown in FIG. 4, a user has entered the following PF (with respect to products in the form of automobiles): “aesthetics.”

Processing proceeds to step S325 where cluster of interest mod 425 determines a cluster of interest. This cluster is the cluster of which the PF forms a constituent part, as determined above at step S310. In some embodiments, a PF may belong to more than one cluster. In other embodiments, the clustering may be defined so that a single feature is only allowed to belong to one cluster. While the product review user contributes to determination of the cluster of interest in the sense of providing the PF, the user does not provide any indication of what features the PF is clustered with to form a cluster. Rather, the clusters were defined by inputs other than product review user input above at step S310. This is true for each cluster if the user provides multiple PFs. If the user provides multiple PFs, then it may happen that all the PFs belong to a single cluster, but this determination would be based on the clustering of step S310 and not on the fact that the multiple PFs happened to be entered by a single product review user. As shown in FIG. 4, in window 452, the features that are clustered with PF “aesthetics” are as follows: (i) color; (ii) upholstery; and (iv) finish.

Processing proceeds to step S330 where ranking mod 430 ranks products of the product set based on the cluster based ratings for the cluster of interest. In other words, the product with the highest cluster rating for the cluster of interest (as determined at step S315) will rank first, the product with the next highest cluster rating will rank second and so on down to the product with the lowest cluster rating. If the user entered multiple PFs, then the ranking may be based upon multiple clusters (and each cluster rating of the multiple clusters may or may not contribute equally in determination of the ranking depending upon the system design). Alternatively, the ranking may be based upon more than just the cluster ratings for the cluster of interest. For example, both the cluster of interest ratings and the PF ratings for the ranked products might be considered in determining a single ranking.

Processing proceeds to step S335 where report mod 435 makes a report to a user (see definition of “user,” below in the definitions sub-section). This report includes at least some indication of the ranking that was based on the cluster based ranking. For example, in this embodiment, the report will present only the highest ranked and the lowest ranked products of the ranking determined at step S330, along with an indication of which was highest ranked and which was lowest ranked. Alternatively, there are many other possible ways to indicate (or at least partially indicate) the ranking, as will be understood by those of skill in the art of presenting ranked lists to users. As a slight variation and as shown in FIG. 4, a higher-to-lower portion of the full cluster-rating-based ranking may be shown in the report made to the user in response to his entry of a PF.

### III. FURTHER COMMENTS AND/OR EMBODIMENTS

Some embodiments of the present disclosure better place the review user by providing a summarized “feature-wise” analysis, which is unlike the scattered and unstructured reviews that are currently conventional. Features are aspects, portions and/or characteristics of products and/or services (commercial, charitable or otherwise). As used herein, the word “products” shall be taken to mean products and/or services. The term “non-service product” shall be taken to mean products that are not in the form of services.

In some embodiments of the present disclosure, the user becomes informed about certain feature dependencies which would have been more difficult to perceive under currently conventional review systems. For example, if a user is considering buying a mobile phone with dual SIM (subscriber identity module), he should also consider battery life, because paging increases, which tends to put a heavy load on the battery. Some embodiments provide a “feature-wise” analysis, which makes this kind of dependency easier to recognize for the review user.

As shown in FIG. 5, computer system 500 suggests a list of the top five products to the end user. System include: text analysis component 520; clustering component 522; preferred feature (PF) selection component 524; and suggestions component 526. Suggestions component 526 includes: PF sub-component 550; and cluster of features (CF) sub-component 552. Among other things, and as will be discussed in detail below, text analysis component 520 “determines polarity” of features component. PF subcomponent 550 uses a WA (weighted average) exclusively based on a single PF, and CF sub-component 552 uses a WA (weighted average) based on CF (cluster of features, also called: clustered feature). The operation of the various components will be discussed in the following paragraphs.

An example of “determining polarity” according to an embodiment of the present invention will now be presented. In this example, text analytics is applied to user reviews to discover the customer sentiments, and, then, based on positive and negative sentiments “polarity” is determined. The product review states as follows: “Mar. 13, 2013. 13:23. I charged my Acme Brand smart phone throughout the night and when I took it out of the charger it was at full. I only made 7 short calls today, but it runs out of battery in 3 hours. It is annoying. How do I preserve the battery life?” Software-based text analysis is performed upon the text of this review to yield the following analysis results: (i) review date=Mar. 13, 2013; (ii) review time=13:23; (iii) Product Type=“Acme brand smart phone”; (iv) Product_Component1=“charger”; (v) Product_Component2=“battery”; (vi) problem=“runs out”; (vii) question=“How do I preserve the battery life?”; and (viii) experience=“annoying”. The foregoing shows how the polarity for the feature “battery,” for a mobile phone, is extracted from the user review.

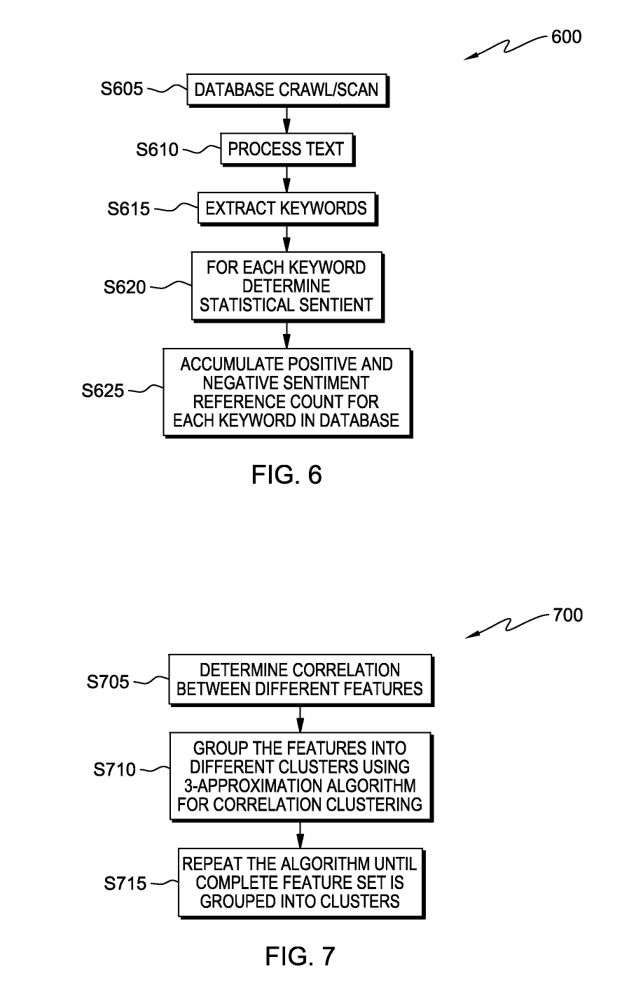

As shown in FIG. 6, method 600 “determines polarity” for the superset of all features for a given product (for example, a given mobile phone, a given digital camera). More specifically, method 600 includes the following steps (with process flow as shown in FIG. 5): (i) step S605, database crawl/scan for relevant product reviews; (ii) step S610, process text of relevant product reviews; (iii) step S615, extract keywords from relevant product reviews; (iv) step S620, for each keyword in each review determine statistical sentiment for that respective review; and (v) step S625, for each keyword in any relevant product review(s), aggregate positive and negative sentiment across all reviews in order to determine aggregate sentiment with respect to each keyword. In this embodiment, text analysis component performs all of the foregoing steps S605 to S625.

As shown in FIG. 5, clustering component 522 will now be discussed. Clustering is the task of partitioning data points into groups based on their similarity.

Clustering component 522 uses a “3-approximation algorithm” for clustering. Consider a signed graph G=(V,E+,E|), where V represent the vertices/nodes in a graph and E+ and E− indicates whether two nodes are similar (+) or different (−). Let each node correspond to a specific feature in a product. Now the task is to cluster the nodes/vertices so the similar objects are grouped together. This can be accomplished by the following method:

(i) Pick a random feature, i such that iεV;

(ii) Set Cluster, C={i} and V′=empty set; (iii) consider a loop for all jεV, such that j≠I;

(iii) If (i, j)εE+ (that is if i and j nodes are similar) then, add j to C, or else (if (i, j)εE−), then add j to V′;

(iv) Let G′ be the sub graph induced by V′; and

(v) Repeat the same steps again, with V′ as the set of vertices.

This process will be repeated until all the features are grouped into appropriate clusters depending upon the correlation among the features.

In the recommended solution, each individual product feature will act as a degenerated dimension and these dimensions will be used to create clusters. The clusters will be created depending upon how good the bearing between related features coexists. These clusters will be dynamic in nature and will keep varying depending upon the correlations among the features. Either of the following scenarios may occur: (i) the same old features will be combined into different cluster combinations as additional product reviews are received; and/or (ii) reviews on the added new features will also have impact on clustering. A process for defining and managing these dynamic clusters is shown in method 700 of FIG. 7. Method 700 includes the following actions (with process flow as shown in FIG. 7): (i) step S705, determine correlation between different features; (ii) step S710, group the features into different clusters using 3-approximation algorithm for correlation clustering; and (iii) step S715, repeat the algorithm until complete feature set is grouped into clusters. Method 700 is periodically repeated, as new product reviews are received and/or as product features are dropped or added, to update the clustering and make the clustering as accurate as possible.

As shown in FIG. 5, the functionality of PF sub-component 550 of suggestion component 526 will now be discussed. Assume a customer wants to buy a mobile phone from an e-commerce site (not shown). After selecting the product, the potential customer is prompted to rank the features as per his preference. Each feature, as per the potential customer's ranking, is assigned a certain weight. This weightage determines the relative importance of each feature. PF sub-component 550 uses WA on product suggestions based upon on a single PF (that is, exclusively considering a single feature that the potential customer has designated as a preferred feature (PF)). The feature ranked highest has the highest “weightage,” and, thus, contributes the maximum proportion of any feature to the derived weighted average.

An equation for calculating the weighted average will now be identified and discussed. The variables w1 to wn are the weightages of different product features numbered 1 to n, and the variables x1 to xn are the aggregated values of all individual user ratings for each feature, 1 to n. These aggregated values include both positive and negative sentiments. The weighted average is equal to ((x1)(w1)+(x2)(w2)+ . . . +(xn)(wn)) divided by (w1+w2+ . . . +wn). Using the weighted average formula, an average value for each product will be calculated considering all the user selected features. The top five products having the highest weighted average feature rating will be displayed to the user in descending order, thereby helping the buyer to select his most preferred product.

As shown in FIG. 5, the functionality of CF sub-component 552 of suggestion component 526 will now be discussed. Technically, the customer might not be aware of other aspects or features, which he should have taken into consideration while buying a product. In this case, the top five products suggested by PF sub-component 550 might not really be the best. To make the top five product suggestions more reliable, CF sub-component 552 facilitates better consideration of the features that also fall in a same “cluster” as the preferred feature(s). Suppose the user selects three features of interest for a product and ranks those features as per his preferences. PF weightage will be inherited by the cluster. In other words, all the features in the cluster will inherit the weightage of the feature that the user explicitly identified as one of the three PFs. If more than one explicitly-assigned PF falls in the same cluster, then, in this embodiment, the highest weightage of the PF will be assigned.

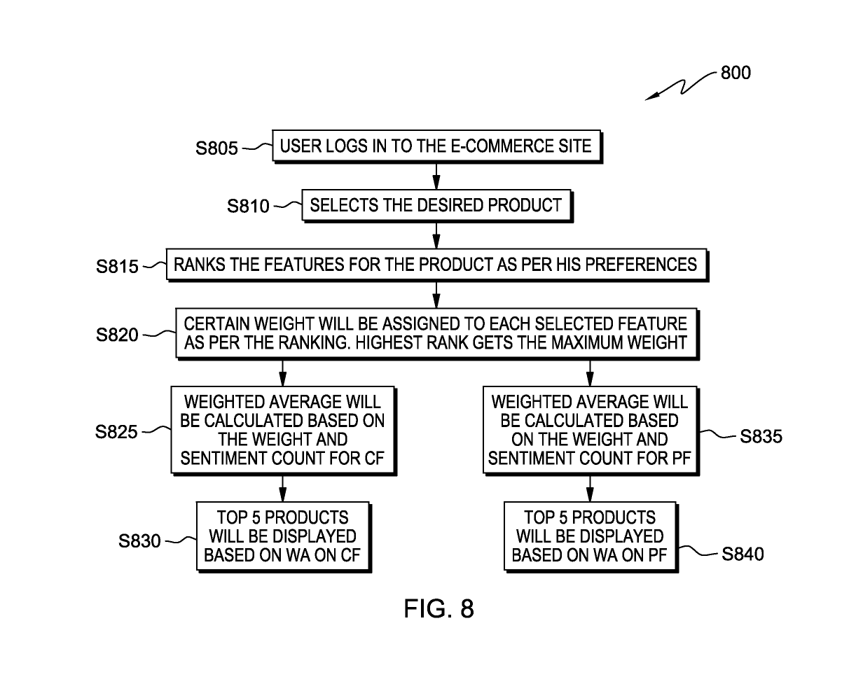

By using a weighted average based upon these three clusters, instead of based merely on three features, the weighted average will tend to reflect a broader set of features, and the top five products suggested will tend to be more accurate. In this embodiment, a set of two top fives, one purely based on PF and the other based on CF, will be presented to the end user, as shown at steps S805 to step S840 of flowchart 800 of FIG. 8.

Some embodiments of the present disclosure may have one, or more, of the following characteristics, features and/or advantages: (i) the clustering of related features of a product into various dimensions and scoring each of these features based on the user reviews; (ii) providing a mechanism for an end user to choose a product by specifying his weightages for various features and then using a weighted average from the feature specific scores; (iii) a mechanism for providing weightages for each of the features and combining them with a feature specific review score to come up with product suggestions; (iv) if the user were to select a certain feature, then a related feature (clustered initially along with this feature during the review analysis) is also picked up and is used to provide additional product suggestions; (v) “feature-wise” reviews of products instead of a single overall review; (vi) determining polarity/sentiment of the reviews; (vii) clustering based on correlation between the features; (viii) searching for a product based on certain preferred features and providing individual weightages to each of these features; (ix) providing additional search results based on those features which happen to fall into the same cluster as the ones chosen by the user; and/or (x) feature correlation using clusters.

There are different ways and/or factors that may be considered when organizing product features into clusters. One possible factor is predetermined knowledge of the product. For example, it is known that a mobile phone with internet communication turned on consumes more battery life. So, any internet-based feature that the mobile phone has may be clustered (or at least more likely to be clustered) with battery consumption. Another possible factor involves measuring the distance between two variables (that is, product features) in the product reviews. Often, reviewers mention related features together. For example, in one sentence, the reviewer may use the word “but”, and in the next sentence say “if you are traveling, switch the internet option off to minimize the battery consumption.” Such words with relatively small “distance” strongly indicate co-related features. There exist software tools for calculating a “distance” between two words in a piece of text, and these tools may be applied in some embodiments of the present invention.

Features may also be clustered using predictive analytics software. In some embodiments, the options for clustering are as follows: (i) Bivariate Correlations; (ii) Partial Correlations; and/or (iii) Distances. These options will be discussed in the following paragraphs.

In Bivariate Correlations, the relationship between two variables is measured. The degree of relationship (how closely they are related) could be either positive or negative. The maximum number could be either +1 (positive) or −1 (negative). This number is the correlation coefficient. A zero correlation indicates no relationship. As an example, are a student's grade and the amount of studying done correlated? One might find that these variables are positively correlated. As a further example, is the number of games won by a basketball team correlated with the average number of points scored per game? Again, bivariate correlations may or may not find a correlation based on empirical data.

The Partial Correlations procedure computes partial correlation coefficients that describe the linear relationship between two variables while controlling for the effects of one or more additional variables. Correlations are measures of linear association. Two variables can be perfectly related, but if the relationship is not linear, a correlation coefficient is not a proper statistic to measure their association. For example, is there a relationship between healthcare funding and disease rates? Although one might expect any such relationship to be a negative one, a study reports a significant positive correlation: as healthcare funding increases, disease rates appear to increase. Controlling for the rate of visits to healthcare providers, however, virtually eliminates the observed positive correlation. Healthcare funding and disease rates only appear to be positively related because more people have access to healthcare when funding increases, which leads to more reported diseases by doctors and hospitals.

The Distances procedure calculates any of a wide variety of statistics measuring either similarities or dissimilarities (distances), either between pairs of variables or between pairs of cases. These similarities, or distance measures, can then be used with other procedures such as factor analysis, cluster analysis, or multidimensional scaling, to help analyze complex data sets. For example, is it possible to measure similarities between pairs of automobiles based on certain characteristics, such as engine size, miles per gallon (MPG), and horsepower? By computing similarities between autos, one can gain a sense of which autos are similar to each other and which are different from each other.

Some embodiments of the present disclosure may have one, or more, of the following characteristics, features and/or advantages: (i) allow the user to rank the products based on his preferences of features and then accordingly assign a weight to the selected features; (ii) account for those features which were not selected but would still fall into the same bucket (or “cluster”) of the feature that the user had initially selected; (iii) display two charts of products having the highest weighted average ratings, one with only his selected features and the other with additional features which are necessary to be taken into account while buying a product; (iv) identify a product based on the set of the features that are of importance to the customer and pick the co-related features based on the user compiled lists, and then rate the product; (v) clusters are created depending upon how good the bearing between related features coexists; (vi) the clusters are dynamic in nature and will keep varying depending upon the correlations among the features; and (vii) use of OM (Opinion Mining) to rank the products based on the selected features as well as taking into account co-related features.

Clustering tools that may be used for determining clusters of product features in some embodiments of the present disclosure may have one, or more, of the following characteristics, features and/or advantages: (i) a clustering Model window, where a user defines minimum and maximum cluster size; (ii) after applying cluster algorithm, data is segmented into different clusters; and/or (iii) snapshots that show on what factor(s) the clustering is determined.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: non-exclusive or; for example, A and/or B means that: (i) A is true and B is false; or (ii) A is false and B is true; or (iii) A and B are both true.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

User: includes, but is not necessarily limited to, the following: (i) a single individual human; (ii) an artificial intelligence entity with sufficient intelligence to act as a user; and/or (iii) a group of related users.

Product: any product, service or combination thereof which has at least one feature capable of being rated; includes, but is not limited to, commercial products, charitable products, social service-related products, insurance-related products, etc.

Common product type: any set of “products” (see definition, above) that compete with each other as alternatives; for example, different passenger vehicles have a common product type; as a further example, different charitable causes have a common product type.

What is claimed is:

1. A method of providing product review related information to a product review user, the method comprising:
determining a plurality of products having a common product type;
determining a plurality of product features of the plurality of products of the common product type; and
determining, independently of any input from the product review user, a plurality of feature clusters, with each feature cluster including at least two features of the plurality of product features.

2. The method of claim 1 further comprising:
determining cluster ratings respectively for each feature cluster of the plurality of feature clusters; and
determining at least a portion of a ranking of the products of the plurality of products based, at least in part, upon the cluster ratings.

3. The method of claim 2 further comprising:
receiving a first preferred feature from the product review user; and
determining which feature cluster(s) include the first preferred feature;
wherein:
determining at least a portion of a ranking of the products of the plurality of products is based, at least in part, upon the cluster ratings for the feature cluster(s) determined to include the first preferred feature.

4. The method of claim 3 further comprising:
reporting an indication of at least a portion of the ranking to the product review user.

5. The method of claim 2 wherein the determination of the plurality of feature clusters is based, at least in part, upon product reviews.

6. The method of claim 5 wherein the determination of the plurality of feature clusters is based, at least in part, upon text analytics performed on a set of product reviews.

7. The method of claim 2 wherein the determination of cluster ratings is based upon feature-wise ratings in a set of product reviews.
